(19) United States
(12) Patent Application Publication
(10) Pub. No.: US 2023/0014140 A1
(43) Pub. Date: Jan. 19, 2023

(54) SMART CONTRACT SYSTEM USING ARTIFICIAL INTELLIGENCE

(71) Applicant: FORTIOR BLOCKCHAIN, LLLP, Sheridan, WY (US)

(72) Inventors: Brian Haney, Bellevue, WA (US); Archie Chadhury, Peachtree City, GA (US)

(21) Appl. No.: 17/375,542

(22) Filed: Jul. 14, 2021

(51) Int. Cl. H04L 9/32; G06N 3/04; G06F 16/23; G06F 16/28; G06N 10/00; H04L 29/06

(52) U.S. Cl. CPC H04L 9/32; G06N 3/0454; G06F 16/2379; G06F 16/28; G06N 10/00; H04L 63/1433

(57) ABSTRACT

The invention is integrated heterogenous smart contracts using artificial intelligence and associated methodologies for transactions on blockchains. Embodiments of the invention are comprised of three elements. First, a user provides data through an online interface. Second, an artificial intelligence computer program processes the data to automatically preprocess and store the data in a centralized database. Third, a second artificial intelligence program interacts between the database and a blockchain to control smart contract processing.

### BACKGROUND TO THE INVENTION

The field of the invention rests at the intersection of two broader fields, artificial intelligence and blockchain. Blockchains are decentralized databases, maintained by distributed networks of computers. Artificial intelligence (AI) refers to computational processes mirroring the human mind's thoughtful deliberation, decision making, and action-oriented behavior. As such, the field of the invention is artificial intelligence software for blockchain smart contracts.

Fundamentally, contracts have three components. First, the parties must intend to exchange something of value. Second, there must be a meeting of the minds as to the exchange of value. Third, there must be a physical representation for the value exchange. As computational systems evolve, the fundamental elements for contracts may be embedded in a logically executable architecture, in the form of computer software or programs. As technology evolves, integration of contract systems with artificial intelligence may foster new innovations.

The term AI has been discussed at length by various scholars and industry leaders. Generally, AI refers to any machine capable of learning, remembering, and taking actions. AI technology is affecting industries across the economy including law, healthcare, and defense. AI automates tasks that were previously done manually, thus digitizing work and improving efficiency. For example, in the legal industry, technology assisted review is changing the discovery process. In other words, AI programs now complete tasks previously only lawyers could do, like classify documents based on relevancy during discovery. Finance is no exception, as the present invention relates to the convergence of artificial intelligence and pecuniary services.

Broadly, AI is a field uniquely positioned at the intersection of several scientific disciplines including computer science, applied mathematics, and neuroscience. The AI design process is meticulous, deliberate, and time-consuming—involving intensive mathematical theory, data processing, and computer programming. All the while, AI's economic value is accelerating. One example of AI is deep learning, a process is inspired by the neurological structures found in the human brain. Both artificial and biological neurons receive input from various sources and map input information to a single output value. Artificial neurons model the strength of synapses, the connectivity between neurons, with weight coefficients. Thus, neural information transfer in the biological brain inspires the way in which modern neural networks operate. At the confluence of AI and blockchain technologies, great opportunity for innovation is available.

As an architecture, a blockchain is a distributed ledger which records transactions between parties. In other words, blockchain technology is both an infrastructure for data storage and management. From a computational perspective, the programming language C++ is the most commonly used for blockchain software development. However, other languages are used in development, for example both Python and C support blockchain construction, with Python becoming far more frequently used. The structure for the blockchain may be considered to have four parts: the network, the public-private key system, the transactional process, and mining.

The blockchain network consists of several computers, called nodes, which are connected via the internet. Each node in the network maintains a transaction record called a ledger, which acts as a parasitic function of the internet. The internet has two fundamental layers, the Transmission Control Protocol (TCP), which manages packet assembly, and the Internet Protocol (IP) which passes packets from one computer to another. Blockchain networks like Bitcoin, Ethereum, and Algorand ultimately rely on TCP and IP to operate and can be viewed as application protocols, sitting on top of the transport layer.

The peer-to-peer network developed to solve the double spending problem, where the same digital coin is spent more than once. For example, the blockchain protocol uses timestamps and a proof-of-work to record a public history of transactions. The timestamp captures the time of transactions on the network, while the proof-of-work validates transactions. The idea is nodes consider the longest chain to be the correct one and will continue working to extend it. In other words, nodes validate the longest chain, which is the only chain that will continue to be extended. The means by which nodes transact is through a system of Public-Private Key Cryptography.

In short, PPKC enables encrypted messages to be sent without the need for a shared key. For example, one of the first PPKC systems was the Rivest-Shamir-Adleman (RSA) algorithm. The RSA algorithm creates a mathematically linked key pair by multiplying two prime numbers together. While, multiplying two prime numbers is computationally inexpensive, figuring out which prime numbers were multiplied to get a number is computationally complex, making it possible to broadcast a public key while reserving a secure private key.

In a blockchain, the transactions are bundled into blocks. A block is a data structure, aggregating transactions for inclusion in a public ledger. Each block consists of a hash value from the previous block, which are transactions happening in the last ten minutes, and a random integer called a nonce. Each block is broadcast to the network, presenting a complex algorithmic problem for validation. Solving blocks typically requires an enormous amount of computation, but verifying the solution is relatively simple. As such, graphics processing units are the most popular hardware tool for blockchain technologies.

A financial transaction communicates to a network an authorized money movement has occurred. The essential elements are a network of parties, an asset moved among those parties, and a process defining the procedures and obligations associated with the movement. In other words, transactions are data structures encoding the value transfer between participants in a system. While costly financial institutions have policed such transactions in the past, blockchain supports a network of traders to perform this function itself. As such, one of the most interesting aspects of blockchain technology is that a central authority does not need to verify transactions.

Algorand is a proof-of-stake blockchain, which evolved to improve security and power efficiency across the blockchain networks by limiting miners to validating transactions proportional to an ownership share. One problem Algorand solves is the majority override, a cryptographic hack which results from a competitive advantage in mining where one actor can control a majority of the nodes with more computing power. To combat the majority override problem, Algorand developed a proof-of-stake chain, differing from classical blockchains, which use a proof-of-work to validate transactions. Algorand also provides a democratic consensus mechanism for voting among nodes in its network.

A smart contract is a computer program which automatically executes, transferring cryptocurrency. In other words, smart contracts are programs that are logically executed on a blockchain without a central oversight. Smart contract technology finds itself drawing on principles of law, finance, and technology to create new type of machine all together. Previously, contracts were only written in human language, rather than live and changing computational systems. Algorand Smart Contracts (ASCs) are programs for blockchain transactions on the Algorand network. Traditionally, ASCs are separated into two main categories, stateful and stateless.

Stateless smart contracts are primarily used for signature authorities but can also validate transactions. In other words, Stateless Smart Contracts are essentially escrow functions. An escrow is a contractual arrangement in which a third party receives and disburses money or property for transacting parties. Usually, contractual performance depends on conditions agreed to by the transacting parties. They validate transactions between two parties, replacing traditional escrow accounts. Stateless Smart Contracts on the Algorand Network also act as signature delegators, signing transactions, thus validating them on the main blockchain network.

Stateful smart contracts are the Algorand Network's backbone. The term stateful refers to the contract's ability to store information in a specific state on the network. Stateful smart contracts are contracts that live on the chain and are used to store data. For example, one type of stateful smart contract is an opt-in contract, allowing the user to elect to receive certain assets. The stateful opt-in contract stores data on the Network, associating the receiving account and the specified asset. On the Algorand Network all assets are tagged with an Asset ID, which is a number corresponding to the asset on the blockchain.

Stateful smart contracts are called through transactions processed by the blockchain according to certain connectivity features. Stateful smart contracts can be combined with all the other features to produce even more complex application types. Stateful smart contracts are used for data storage, both global or local, and functional processing on the Algorand blockchain. For example, a stateful smart contract may be used as a voting method, storing data globally based on the result of several votes.

However, one problem persisting on blockchain networks is a computational complexity in transferring information. For example, where the goal is to transact using a digital asset, the problem is then there is no way to create a single executable for a transaction. In other words, current transaction methods are too complex and lack single script software systems. This prevents many smart contracts from being legally valid contracts according to standard conventions in contract law. Therefore, there exists a need for a new type of smart contract, which is both user friendly and heterogeneous in operability between different syntactic structures and blockchains.

### SUMMARY OF THE INVENTION

The invention is systems and methodologies for Algogeneous Smart Contract construction, transactions, and deployment. Solving the blockchain purchasing problem by providing a new way to transact on blockchain technologies, Algogeneous Smart Contracts converge several smart contract structures with AI technologies including machine learning, knowledge embodied programs, and embedded intelligence computer programs. In doing so, the disclosed systems and methodologies improve the usability, scalability, and scope of application for smart contract technologies and online transactions.

First, a user provides smart contract or financial data through an online user interface. Second, an artificial intelligence computer program processes the data and automatically cleans the data before transferring the data to an aggregated database. Third, a second artificial intelligence program commands control flow between the database and blockchain to deploy Algogeneous Smart Contracts. The disclosed methodologies may serve several purposes. For example, they may be used to purchase digital assets or exchange value across blockchain or other information networks.

### BRIEF DESCRIPTION OF THE DRAWINGS

FIG. 1 illustrates embodiments of the present invention as an information flow model including users interacting with an Algogeneous Smart Contract.

FIG. 2 illustrates embodiments of the present invention as an information flow model including smart contract data and blockchain selection.

FIG. 3 illustrates embodiments of the present invention as an information flow model including user information provided through a web interface.

### DETAILED DESCRIPTION OF THE INVENTION

In certain embodiments, Algogeneous Smart Contracts allow multiple tasks to be efficiently integrated within one intelligent function, all on the Algorand blockchain. A smart contract by itself is a payment function, including functionality that both stores information and validates a transaction. Algorand's Smart Contracts can be linked through a reference pattern in which one smart contract's output can be dependent on another smart contract's logic. In short, an Algogeneous Smart Contract is a smart contract that manages to achieve the functionality of both a stateless and stateful smart contract in a singular system and then combines the singular system with AI analysis.

In certain embodiments, a smart contract is a computer program which automatically executes, moving decentralized and other digital assets. Moreover, smart contracts allow for automation and law to be written in transactional programs. More particularly, smart contracts on the Algorand Network avoid the high fees and mining costs associated with smart contracts developed on other blockchains. Algorand Smart Contracts (ASCs) are computer programs with various functions on the Algorand Network. The cryptographic code behind ASCs include several systems and methods encrypted within the Algorand Network. Traditionally, there were two main types of ASCs, and Stateless Smart Contracts and Stateful Smart Contracts.

In certain embodiments, Stateless Smart Contracts validate transactions between two parties, like a traditional escrow account. In other words, Stateless Smart Contracts approve or deny transactions between parties. On the Algorand Network, Stateless Smart Contracts also act as signature delegators, validating smart contracts on the main blockchain network. For example, a Stateless Smart Contracts may validate a transaction between the user and an asset manager, for a new digital currency.

In certain embodiments, Stateful Smart Contracts control the logic for blockchain transactions. The term stateful refers to the contract's ability to store information in a specific state on the network. Stateful Smart Contracts are contracts that live on the chain and are used to store data. For example, one type of Stateful Smart Contract is an opt-in contract, allowing the user to receive digital assets. The stateful opt-in contract stores data on the Algorand Network by associating the receiving account and the specified asset in blockchain storage.

In certain embodiments, Heterogeneous Smart Contracts integrate both stateless smart contract and stateful smart contract functionality into a singular smart contract, which may be deployable in a single script executable. Algogeneous Smart Contracts advance the Heterogeneous Smart Contract architecture by including artificial intelligence computer programs, capturing human knowledge or intuition in the computational process. Both Heterogeneous Smart Contracts and Algogeneous Smart Contracts may be deployed from a command line interface, using various computer software languages such as C++, Python, Teal, or Solidity.

In certain embodiments, various forms of AI may be integrated within a Heterogeneous Smart Contract, Stateful Smart Contract, or Stateless Smart Contract. Broadly, and as used herein, AI refers to any computer program replicating the thoughtful processes associated the human mind. Certain types of AI used in various embodiments of the present invention include machine learning, neural networks, embedded intelligence. Machine learning is a process by which programs improve over time and through experience. Neural networks are used for machine learning using matrix multiplication and derivate calculations to learn from data over time. Embedded intelligence is a type of AI that utilizes human knowledge captured in a formal software architecture for decision making.

In certain embodiments, the disclosed invention utilizes reinforcement learning, which is a specific type of AI computer program. Reinforcement learning software optimizes program performance according to a reward function. The process involves building models and developing systems for decision making which are embedded in software programs. Reinforcement learning algorithms usually contain three elements: (1) model: the description of the agent-environment relationship; (2) reward: the agent's goal; and (3) policy: the decision function. In practice, engineering reinforcement learning systems is a meticulous and time-consuming task, but the effort is worthwhile because reinforcement learning programs learn without supervision.

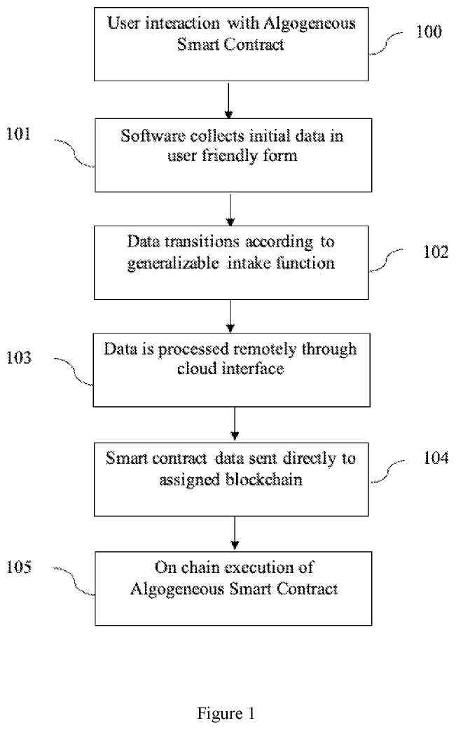

As shown in FIG. 1, in certain embodiments of the present invention, users interact with an Algogeneous Smart Contract interface 100. The interface then collects the user's data and transitions the data 101 using to a generalizable intake function 102. The data is processed remotely using cloud computing resources 103. The cloud resources then direct the smart contract data to an assigned blockchain 104, for example, Algorand. An AI computer program then performs an on chain execution of the smart contract 105.

In certain embodiments of the invention, the invention is a methodology for heterogeneous smart contract deployment. In certain embodiments, the invention is comprised of three steps. First, a user provides smart contract or financial data through an online user interface 101. Second, an artificial intelligence computer program 102 processes the data and automatically cleans the data 103 before transferring the data to an aggregated database. Third, a second artificial intelligence program commands control flow between the database and blockchain 104 to deploy heterogeneous smart contracts 105. The deployed smart contracts may serve several purposes. For example, they may be used to purchase digital assets or exchange value across blockchain or other information networks.

In certain embodiments of the invention, the disclosed methods include interoperability between stateful and stateless smart contracts. Where smart state contracts must be stateful or stateless, heterogenous contracts may be stateful, stateless, or both.

$${S}_{C} = 0 ⊕ 1 \qquad ( 1 )$$

$${A}_{C} = 0 ⊗ 1 \qquad ( 2 )$$

$${A}_{C} \to {A}_{N} \qquad ( 3 )$$

$${A}_{C} \to {A}_{N} = {\prod }_{i = 0} {F}_{i}^{n} \qquad ( 4 )$$

$${F}_{i} = [ 0 , … , n ] \qquad ( 5 )$$

Equation (1) and Equation (2) define a state smart contract, which may be stateful or stateless and an Algogeneous Smart Contract respectively. Equation (3) and Equation (4) represent the transition between an Algogeneous Smart Contract and the Algorand Network. Equation (5) is an array which may include an arbitrary list of factors Fᵢ.

In certain embodiments of the invention, the disclosed methods include Matrix transformations across both linear ⊕ and nonlinear ⊗ operators. The operations form the basis for a new blockchain technology, the converter. Heterogeneous converters are intelligent programs between the internet and the blockchain. There are two types of converters, linear and nonlinear.

$$[ \begin{matrix}{x}_{l} \\ {x}_{m} \\ {x}_{n}\end{matrix} ] ⊕ [ \begin{matrix}{x}_{n} & {x}_{m} & {x}_{l}\end{matrix} ] ⊗ [ \begin{matrix}{x}_{n} \\ {x}_{m} \\ {x}_{l}\end{matrix} ] ⊗ [ \begin{matrix}{x}_{l} & {x}_{m} & {x}_{n}\end{matrix} ] ⊕ [ \begin{matrix}{x}_{l} \\ {x}_{m} \\ {x}_{n}\end{matrix} ] \qquad ( 6 )$$

$$[ \begin{matrix}{x}_{n} \\ {x}_{m} \\ {x}_{l}\end{matrix} ] ⊗ [ \begin{matrix}{x}_{l} & {x}_{m} & {x}_{n}\end{matrix} ] ⊕ [ \begin{matrix}{x}_{n} \\ {x}_{m} \\ {x}_{l}\end{matrix} ] ⊕ [ \begin{matrix}{x}_{n} & {x}_{m} & {x}_{l}\end{matrix} ] ⊗ [ \begin{matrix}{x}_{n} \\ {x}_{m} \\ {x}_{l}\end{matrix} ] \qquad ( 7 )$$

Equation (6) is a nonlinear blockchain converter. Equation (7) is a linear blockchain converter.

In certain embodiments of the invention, the disclosed methods include a new Algorand Smart Contract (ASC), the Algogeneous Smart Contract. While traditionally, ASCs are separated into two main categories, stateful and stateless, the Algogeneous Smart Contract offers a third and interoperable ASC. Stateless smart contracts are primarily used for signature authorities and stateful smart contracts are used for data storage and functional processing on the Algorand blockchain. However, Algogeneous Smart Contracts may be used for signature validation, data storage, and functional processing on the Algorand blockchain.

In certain embodiments, the programming language used for Algogeneous Smart Contract development may be Python. In such embodiments, the Python may be used or integrated with PyTeal or the Algorand Python-SDK. PyTeal is a Python compiler for Algorand's Transaction Execution Approval Language (TEAL), which is a smart contract computing language. The front-end interface for Algogeneous Smart Contracts may developed using Flask, which includes a Python Library designed for web-development and allows developers to render HTML files directly with interoperable communications linking to a Python backend software stack.

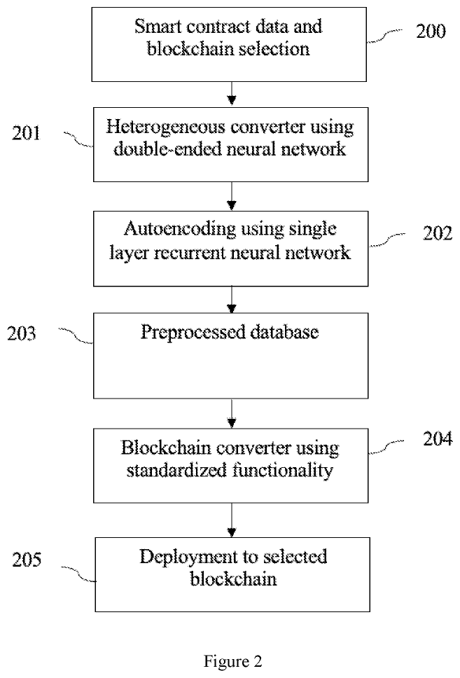

As shown in FIG. 2, in certain embodiments of the present invention, users provide smart contract data and blockchain selection 200 from various blockchains, such as Algorand or Ethereum. Then, a heterogeneous converter using double-ended neural network 201 autoencoder the data using single layer recurrent neural network 202. The data is automatically preprocessed and stored in a database 203 using a blockchain converter with standardized functionality 204. Finally, the smart contract is deployed to selected blockchain 205 and the data is recorded.

In certain embodiments, Algogeneous Smart Contracts utilize a mixture of security techniques including features inherent within the Algorand blockchain, but with additional RSA protections at various network layers. Moreover, as Algogeneous technology evolves, further developments will focus on infusing AI within the cybersecurity mechanism. The cybersecurity mechanism may analyze the preprocessed database 203. Specifically, the infusion will involve integrating neural networks for predicting and identifying security vulnerabilities to optimize the smart contract's security mechanism toward the safest possible transaction technology through deployment to a selected blockchain 205.

In certain embodiments of the invention, the disclosed methods include information transfer methods which utilize one or more single layer recurrent neural networks, The neural networks may be used for several purposes among certain embodiments including adding security features and network validation processes.

$$\begin{matrix}{x}_{l} \to {x}_{l + 1} \\ {x}_{m} \to {x}_{m + 1} \\ {x}_{n} \to {x}_{n + 1}\end{matrix} \begin{matrix}\to \\ \to \end{matrix} x ° \qquad ( 8 )$$

$$x ° \begin{matrix}← \\ ←\end{matrix} \begin{matrix}{x}_{n + 1} ← {x}_{n} \\ {x}_{m + 1} ← {x}_{m} \\ {x}_{l + 1} ← {x}_{l}\end{matrix} \qquad ( 9 )$$

$$\begin{matrix}\begin{matrix}{x}_{n} \to {x}_{n + 1} \\ {x}_{m} \to {x}_{m + 1} \\ {x}_{l} \to {x}_{l + 1}\end{matrix} \begin{matrix}\to \\ \to \end{matrix} x ° & {x}^{*} & x ° \begin{matrix}← \\ ←\end{matrix} \begin{matrix}{x}_{l + 1} ← {x}_{l} \\ {x}_{m + 1} ← {x}_{m} \\ {x}_{n + 1} ← {x}_{n}\end{matrix}\end{matrix} \qquad ( 10 )$$

Equation (8) is an actor network for a single layer recurrent neural network. Equation (9) is a critic network for a single layer recurrent neural network. Equation (10) is dualling recurrent neural networks. The dualling derivative juxtaposes the actor against the critic, which transposes the actor.

In other embodiments of the invention, the disclosed methods include information transfer methods which utilize one or more linear neural networks,

$$\begin{matrix}{x}_{l} ⊕ {x}_{l + 1} \\ {x}_{m} ⊕ {x}_{m + 1} \\ {x}_{n} ⊕ {x}_{n + 1}\end{matrix} \begin{matrix}⊕ \\ ⊕\end{matrix} x ° \qquad ( 10 )$$

$$x ° \begin{matrix}⊕ \\ ⊕\end{matrix} \begin{matrix}{x}_{n + 1} ⊕ {x}_{n} \\ {x}_{m + 1} ⊕ {x}_{m} \\ {x}_{l + 1} ⊕ {x}_{l}\end{matrix} \qquad ( 11 )$$

$$\begin{matrix}\begin{matrix}{x}_{n} ⊕ {x}_{n + 1} \\ {x}_{m} ⊕ {x}_{m + 1} \\ {x}_{l} ⊕ {x}_{l + 1}\end{matrix} \begin{matrix}⊕ \\ ⊕\end{matrix} x ° & {x}^{*} & x ° \begin{matrix}⊕ \\ ⊕\end{matrix} \begin{matrix}{x}_{l + 1} ⊕ {x}_{l} \\ {x}_{m + 1} ⊕ {x}_{m} \\ {x}_{n + 1} ⊕ {x}_{n}\end{matrix}\end{matrix} \qquad ( 12 )$$

Equation (10) is an actor network for a linear neural network. Equation (11) is a critic network for a linear neural network. Equation (12) is dualling linear neural networks.

In other embodiments of the invention, the disclosed methods include information transfer methods which utilize one or more nonlinear neural networks.

$$\begin{matrix}{x}_{l} ⊗ {x}_{l + 1} \\ {x}_{m} ⊗ {x}_{m + 1} \\ {x}_{n} ⊗ {x}_{n + 1}\end{matrix} \begin{matrix}⊗ \\ ⊗\end{matrix} x ° \qquad ( 13 )$$

$$x ° \begin{matrix}⊗ \\ ⊗\end{matrix} \begin{matrix}{x}_{n + 1} ⊗ {x}_{n} \\ {x}_{m + 1} ⊗ {x}_{m} \\ {x}_{l + 1} ⊗ {x}_{l}\end{matrix} \qquad ( 14 )$$

$$\begin{matrix}\begin{matrix}{x}_{n} ⊗ {x}_{n + 1} \\ {x}_{m} ⊗ {x}_{m + 1} \\ {x}_{l} ⊗ {x}_{l + 1}\end{matrix} \begin{matrix}⊗ \\ ⊗\end{matrix} x ° & {x}^{*} & x ° \begin{matrix}⊗ \\ ⊗\end{matrix} \begin{matrix}{x}_{l + 1} ⊗ {x}_{l} \\ {x}_{m + 1} ⊗ {x}_{m} \\ {x}_{n + 1} ⊗ {x}_{n}\end{matrix}\end{matrix} \qquad ( 15 )$$

Equation (13) is an actor network for a nonlinear neural network. Equation (14) is a critic network for a nonlinear neural network. Equation (15) is dualling nonlinear neural networks.

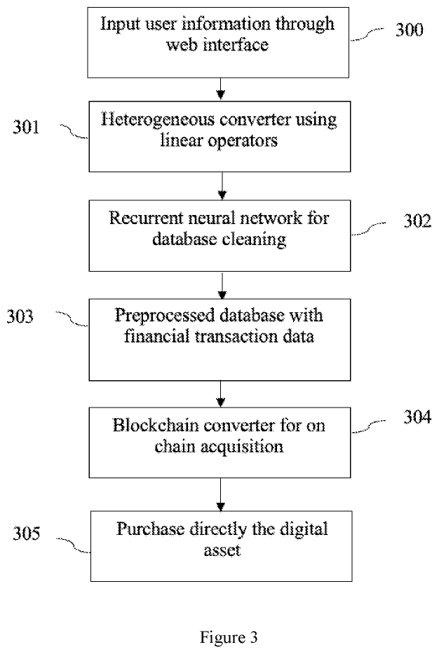

As shown in FIG. 3, in certain embodiments of the present invention, user information provided through a web interface 300. Then, a heterogeneous converter using linear operators 301 applies a neural network for database cleaning 302 to the data for preprocess. The data is preprocessed and aggregated to a database with cryptographic and financial transaction data 303 using blockchain converter for on chain acquisition 304. Finally, the user makes a direct purchase of a digital asset 305, such as Algo, the Algorand cryptocurrency, or Choice Coin.

In certain embodiments, the invention makes use of a heterogeneous converter. The Heterogeneous converter aggregates data from the user, processing the data to be deployed on chain. The heterogeneous converter processes both stateful and stateless functionality to support the Algogeneous Smart Contract. The heterogenous converter may use both linear 301 and nonlinear operators to assign values and functionally process information. Moreover, the heterogeneous converter may utilize a double-ended neural network 201 for predictive processing.

In certain embodiments, the invention utilizes an intuitive platform for users to create an account and exchange their Algos for an Algorand Standard Asset or another digital asset, such as Ethereum or Bitcoin. One competitive advantage for using the disclosed invention is operating on the Algorand Network using AI technologies for financial transfer. This will help mainstream investors such that they can rely on a machine learning protocol that similarly gives them a say with regards to how their digital assets will grow. A similarly large competitive advantage is simplicity. The stateless smart contract will send and verify the actual signatures, while the stateful smart contract will check the logic and ensure that the user sent the Algo.

In certain embodiments, the present invention provides a user interface allowing users to receive the token upon creation and document the specific process that integrates both stateful and stateless smart contracts. Blockchain users want instant gratification in the form of short-term financial returns. In fact, to some extent, every consumer has at least some demand for more present capital. Moreover, software which utilizes the invention may enable the user to send a transaction of Algo, check if the user sent the Algo, and then send the user one Unit of another cryptocurrency, with a name which may include Ether, Bitcoin, Balancer, Choice, Choice Coin, Uniswap, Loopring, Auto, Rocket, or GitCoin.

In certain embodiments, the Algogeneous Smart Contract offers a third and interoperable ASC. Stateless smart contracts are primarily used for signature authorities and stateful smart contracts are used for data storage and functional processing on the Algorand blockchain. However, Algogeneous Smart Contracts may be used for signature validation, data storage, and functional processing on the Algorand blockchain. The Algogeneous contract utilizes an embedded intelligence, a type of AI in for contract analysis. The AI checks to ensure the technical smart contract is legally valid according to law.

In certain embodiments, the Algogeneous AI may assure the invention meets certain legal requirements using an embedded intelligence. The embedded intelligence includes legal knowledge formalized according to certain defined factors and weights, which may be averaged for a truth representation using both Boolean and scaled logic.

$${F}_{i}^{{W}_{i}} = [ {f}^{{w}_{1}} … {f}^{{w}_{n}} ] \qquad ( 16 )$$

$$ai = \sqrt[{\sum }_{j = 1}^{n} {w}_{j}]{{\prod }_{i = 1}^{n} {F}_{i}^{{W}_{i}}} \qquad ( 17 )$$

Equation (16) defines an array of factors and Equation (17), the AI Equation, defines a weighted average processing the array according to instructions from an embedded agent. The embedded agent formalizes knowledge for contractual analysis—assuring the contract is logically, legally, and transactionally valid.

In certain embodiments, the Algogeneous AI may return a Boolean value for a contract's legitimacy.

$$if \{ \begin{matrix}1 - ai = 0 ; return = true \\ else ; return = false\end{matrix} \qquad ( 18 )$$

$$s = \{ \begin{matrix}{f}_{i} \to 0 ⊗ 1 \\ {f}_{…} \to 0 ⊗ 1 \\ {f}_{n} \to 0 ⊗ 1\end{matrix} \qquad ( 19 )$$

Equation (18) evaluates the ai analysis. Equation (19) is an algorithm for searching and evaluating the factor array in Equation (16) in the event the contract fails under the ai analysis.

The invention is useful in several ways. In certain embodiments, the invention may be used to transact between two or more parties. In such embodiments, the Algogeneous smart contract may allow users to exchange different digital assets or other types of assets. For example, two users may exchange the Algorand cryptocurrency, Algo, for United States Dollars (USD). Or, two users may trade USD for an Algorand Standard Asset (ASA), such as Choice Coin.

In other embodiments, the invention may be used to facilitate cryptocurrency purchasing, exchanging, or trading. In such embodiments, the Algogeneous Smart Contract may perform functionality using AI technologies, where the AI provides a user information regarding the nature and status of a purchase, exchange, or trade. Additionally, the AI may preprocess data 102 or analyze data in post-process for validating transactions 304.

In certain embodiments, the present invention is a method for heterogeneous smart contract processing. The method involves a user first providing data entering data to a database through a user interface, which may be compiled using cloud computing resources 103. A first AI computer program 202 then preprocesses the data in a database 203. Then, the smart contract processes the data with an AI program 204 to validate the information and data. The smart contract, then deploys the data to a blockchain technology or software platform 105, such as Ethereum, Bitcoin, Algorand, or Uniswap.

In certain embodiments, the present invention is a method for smart contract processing, using cloud computing resources. In such embodiments, the cloud computing resources may include remote processing 102 using quantum computers, such as an adiabatic quantum computer or gate model quantum computer. Generally, quantum computers are computers which process information using superconducting qubits and charged particles and metals to improve computational efficiencies compared to classical computing systems. Adiabatic quantum computers differ from gate model quantum computers in that adiabatic quantum computers utilize the natural quantum properties of physics to process information, where gate model quantum computers directly manipulate sub-atomic particles to perform computation. The methods of the present invention may be run remotely on a quantum computer via a cloud interface 103.

It is to be understood that while certain embodiments and examples of the invention are illustrated herein, the invention is not limited to the specific embodiments or forms described and set forth herein. It will be apparent to those skilled in the art that various changes and substitutions may be made without departing from the scope or spirit of the invention and the invention is not considered to be limited to what is shown and described in the specification and the embodiments and examples that are set forth therein. Moreover, several details describing structures and processes that are well-known to those skilled in the art and often associated with blockchain and AI technologies are not set forth in the following description to better focus on the various embodiments and novel features of the disclosure of the present invention. One skilled in the art would readily appreciate that such structures and processes are at least inherently in the invention and in the specific embodiments and examples set forth herein.

One skilled in the art will readily appreciate that the present invention is well adapted to carry out the objectives and obtain the ends and advantages mentioned herein as well as those that are inherent in the invention and in the specific embodiments and examples set forth herein. The embodiments, examples, methods, and compositions described or set forth herein are representative of certain preferred embodiments and are intended to be exemplary and not limitations on the scope of the invention. Those skilled in the art will understand that changes to the embodiments, examples, methods and uses set forth herein may be made that will still be encompassed within the scope and spirit of the invention. Indeed, various embodiments and modifications of the described compositions and methods herein which are obvious to those skilled in the art, are intended to be within the scope of the invention disclosed herein. Moreover, although the embodiments of the present invention are described in reference to use in connection with blockchain and artificial intelligence technology, ones of ordinary skill in the art will understand that the principles of the present inventions could be applied to other types of computers for a wide variety of applications.

We claim:

1. A computing device for heterogeneous smart contract processing, the computing device comprising at least one processor and at least one memory device, the processor configured to: store, in a database using cloud computing resources, user input data input via a user interface; generate smart contract data using a first artificial intelligence computer program based on the user input data stored in the database; and transform the smart contract data using a second artificial intelligence program to store the smart contract data as a smart contract in a blockchain structure, wherein the smart contract is heterogeneous.

2. The computing device of claim 1, wherein the cloud computing resources are configured to provide remote access to an adiabatic quantum computer processing the smart contract data.

3. The computing device of claim 1, wherein the cloud computing resources are configured to provide remote access to a supercomputer processing the smart contract data.

4. The computing device of claim 1, wherein the blockchain structure is an Algorand blockchain structure.

5. The computing device of claim 1, wherein the blockchain structure is a proof-of-stake blockchain, and the second artificial intelligence program validates the smart contract using an embedded intelligence, using formalized legal knowledge.

6. The computing device of claim 1, wherein the blockchain structure is a proof-of-work blockchain.

7. The computing device of claim 1, wherein the processor is further configured to receive, via the user interface, a selection from a list of a type of the blockchain structure on which the smart contract is stored, the list including at least one of an Algorand blockchain structure, an Ethereum blockchain structure, and a Bitcoin blockchain structure.

8. A method for heterogeneous smart contract processing, the method comprising user input data entering a database through a user interface compiled using cloud computing resources, to process smart contract data using an artificial intelligence computer program, further processing the data with a second artificial intelligence program, deploying such data on a blockchain technology or software platform.

9. The method of claim 8, wherein the cloud computing resources are providing remote access to an adiabatic quantum computer processing the smart contract data.

10. The method of claim 8, wherein the cloud computing resources are providing remote access to a supercomputer processing the smart contract data using one linear neural network and one nonlinear neural network.

11. The method of claim 8, wherein the blockchain technology on which the smart contract is deployed is Algorand, and the first artificial intelligence computer program and the second artificial intelligence computer converge, processing information as a deep reinforcement learning algorithm, receiving information from the user, inputting information, and further recording the information provided by the user on the Algorand blockchain.

12. The method of claim 8, wherein the blockchain technology on which the smart contract is deployed is a proof-of-stake blockchain, and the second artificial intelligence program validates the smart contract using an embedded intelligence, using formalized legal knowledge.

13. The method of claim 8, wherein the blockchain technology on which the smart contract is deployed is a proof-of-work blockchain.

14. The method of claim 8, wherein a user selects, determining the blockchain technology on which the smart contract is deployed for a list including, Algorand, Ethereum, and Bitcoin.

15. A method for cryptographic transactions on blockchains, the method performed by a computing device including at least one processor and at least one memory device, the method comprising: storing, by the computing device, in a database using cloud computing resources, user input data input via a user interface; compiling, by the computing device, using a first artificial intelligence computer program, a smart contract based on the user input data, the smart contract including smart contract data; and transforming, by the computing device, the smart contract data using a second artificial intelligence program, to store the smart contract in a blockchain structure, the second artificial intelligence program utilizing an embedded intelligence integrating formalized knowledge, validating the smart contract and deploying the smart contract on the blockchain.

16. The method of claim 15, wherein the cloud computing resources are configured to provide remote access to an adiabatic quantum computer configured to process the smart contract data.

17. The method of claim 15, wherein the blockchain structure on which the smart contract is deployed is an Algorand blockchain structure, the deployment protected by two artificial intelligence computer programs using neural networks for cybersecurity, processing data to identify security vulnerabilities.

18. The method of claim 15, wherein the blockchain structure is an Ethereum blockchain structure.

19. The method of claim 15, wherein the first artificial intelligence computer program and the second artificial intelligence computer program are singularized as a deep reinforcement learning algorithm, further comprising two neural network computer programs and one reinforcement learning computer program.

20. The method of claim 15, further comprising receiving, by the computing device via the user interface, a selection from a list of a type of the blockchain structure for storing the smart contract, the list including at least one of an Algorand blockchain structure, an Ethereum blockchain structure, and a Bitcoin blockchain structure.
